(19) United States
(12) Patent Application Publication
(10) Pub. No.: US 2008/0199644 A1
(43) Pub. Date: Aug. 21, 2008

(54) Bag with window and method for making the same

(75) Inventor: Shih-I Chang, Changhua County (TW)

Correspondence Address: Chang, Shih-I, P.O. Box 44-2049, Taipei, 10668, omitted

(73) Assignee: TEHN-LIN ENTERPRISE CO., LTD

(21) Appl. No.: 11/987,588

(22) Filed: Dec. 3, 2007

(30) Foreign Application Priority Data
Feb. 16, 2007 (TW) 096105998

(51) Int. Cl. B32B 1/00; B32B 38/04

(52) U.S. Cl. 428/35.2; 156/256

(57) ABSTRACT

A method for making a bag with a window includes a step of making an outer surface which is composed of a first layer and a second layer glued to the first layer; a step of making a through hole through the outer surface; a step of making an inner surface which is composed of a high isolation layer and a plastic layer, and a step of connecting the second layer to the high isolation layer by way of non-liquid adhesive so as to form a bag with a window. The high isolation layer prevents air and moist from entering into the bag so as to keep freshness of the food received in the bag.

### BACKGROUND OF THE INVENTION

(1) Field of the Invention

The present invention relates to a bag and a method for making the bag which includes a window.

(2) Description of the Prior Art

A conventional bag usually made by non-transparent material such as paper or aluminum foil, and food or product is received in the bag. However, in order to attract customers attentions, some bags includes windows through which the customers can see the contents in the bags.

The window is covered by a transparent plastic sheet which is glued to the inside or outside of the bag. Nevertheless, the plastic sheet includes multiple tiny holes through which moist and air can enter the bag and affect the freshness of the food or product in the bag. Besides, the glue may also penetrate the bag or the plastic sheet.

A latest sheet for the window of bags includes a printed film and a cover film which is glued to the printed film so as to form a first film. A transparent film is glued to the printed film of the first film to form a second film.

The first film includes a window so that the customers can see the goods in the bag via the transparent film. The glue is prevented to enter the surface material when the transparent film is glued to the cover film. Nevertheless, the transparent film is glued to the printed film and hide the nature of the material of the printed film.

Because the first film has a through hole as the window so that the glue on the gluing roller is in contact with the cover film and may leak from the periphery of the through hole, The surplus glue forms stiff and serrated periphery along the window. Another way to glue the transparent film is to coat the glue and a moist roller is used to avoid the glue leak, the moist roller makes the second film to be blurred.

### SUMMARY OF THE INVENTION

The present invention relates to a method for making a bag with a window and the method comprises the following steps:

step 1: making an outer surface which is composed of a first layer and a second layer glued to the first layer;

step 2: making a through hole through the outer surface;

step 3: making an inner surface which is composed of a high isolation layer and a plastic layer, and

step 4: connecting the second layer to the high isolation layer by way of non-liquid adhesive so as to form a bag with a window. The high isolation layer is located at the through hole so as to prevent the adhesive from penetrating through the high isolation layer.

The primary object of the present invention is to provide a bag which includes a high isolation layer so as to provide better sealing feature and moist and air cannot enter through the window. Besides, the high isolation layer prevents the adhesive on the roller from gluing the inner surface so that the window is clear.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bag with window of the present invention;

FIG. 2 shows the bag of the present invention is squeezed to be flat;

FIG. 2A is a cross sectional view to show the inner and outer surfaces of the bag;

FIG. 3 shows the structure of the bag;

FIG. 4 is a cross sectional view to show the inner surface of the bag;

FIG. 5 is a cross sectional view to show the outer surface of the bag;

FIG. 6 is a cross sectional view to show the bag at the position where the window is located, and

FIG. 7 shows another embodiment of the bag of the present invention.

### DETAILED DESCRIPTION OF THE PREFERRED EMBODIMENTS

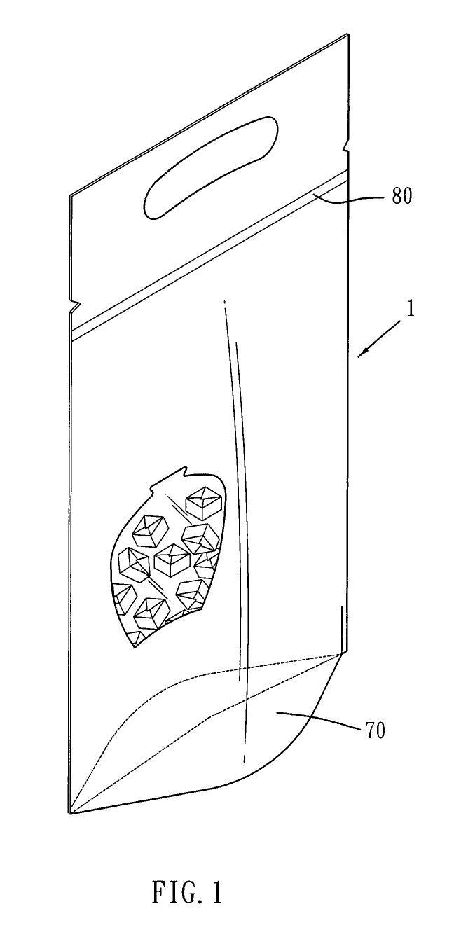

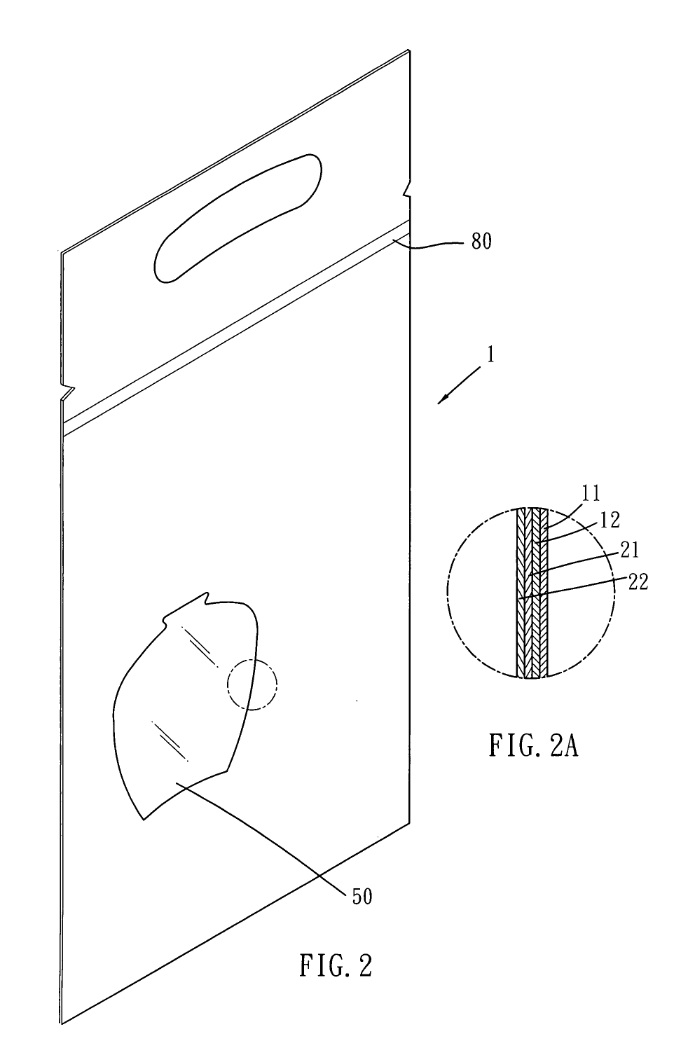

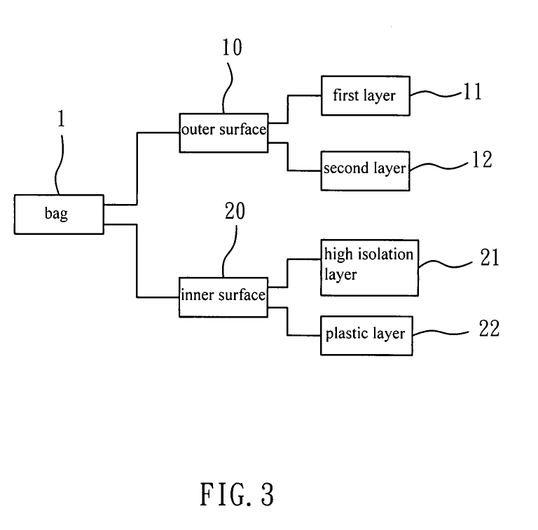

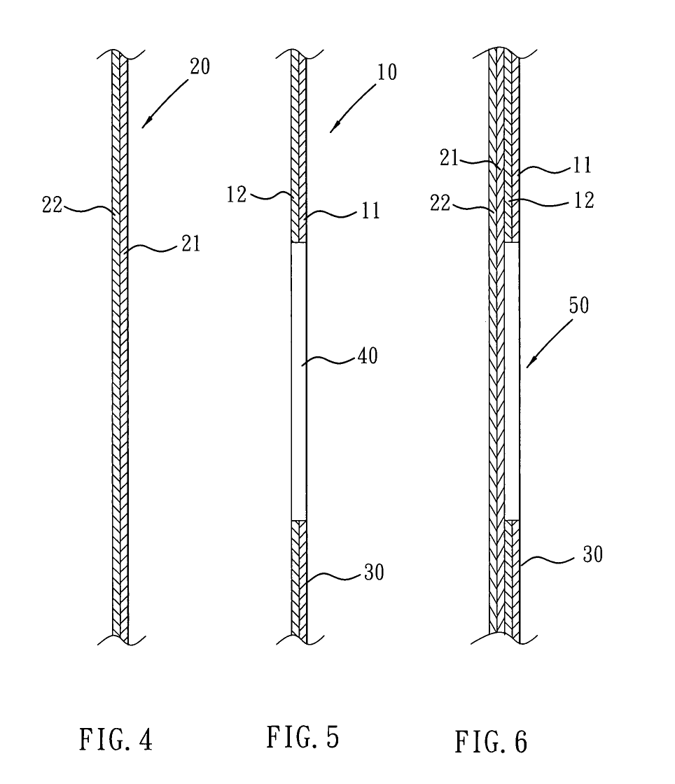

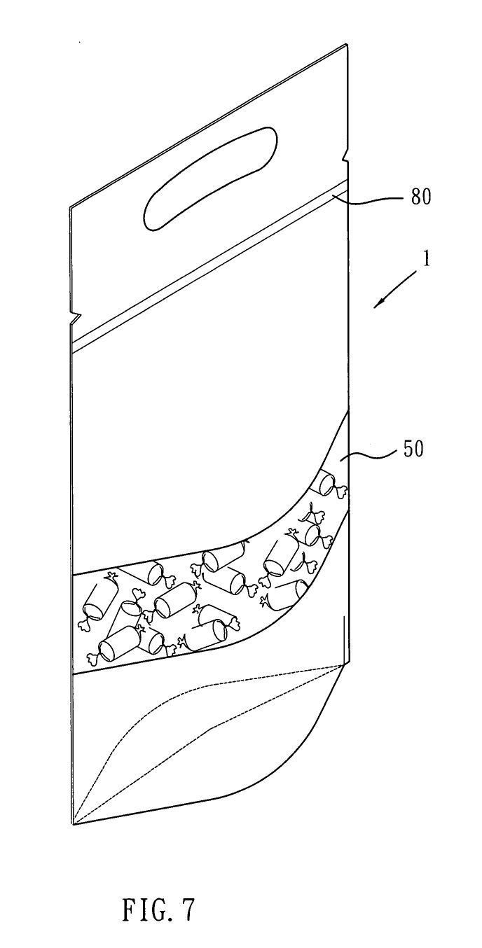

Referring to FIGS. 1, 2, 2A, 3 to 6, the bag 1 of the present invention of the present invention comprises a closed bottom 70 and a open top, a sealing device 80 is located close to the open top so as to seal the open top when needed.

The bag 1 includes an outer surface 10 composed of a first layer 11 connected to a second layer 12. The connection of the first layer 11 and the second layer 12 is made by way of liquid adhesive or non-liquid adhesive. A through hole 40 defined through the outer surface 10. The first layer 11 is made by electro-coating aluminum foil film, aluminum foil, paper or non-woven fabric.

An inner surface 20 is composed of a high isolation layer 21 and a plastic layer 22 which is connected to the high isolation layer 21 by way of liquid adhesive or non-liquid adhesive.

The second layer 12 is connected to the high isolation layer 21 by way of non-liquid adhesive so as to form the bag. The area where the through hole 40 is located forms a window 50. The first layer 11 includes a printed pattern 30 such as a logo or characters.

The second layer 12 prevents the adhesive from contacting the outer surface 10 and from leakage. The second layer 12 also enhances the structural strength of the outer surface 10.

The method for making the bag 1 comprises the following steps:

step 1: making an outer surface 10 which is composed of a first layer 11 and a second layer 12 glued to the first layer 11, the first layer 11 can be made by electro-coating aluminum foil film, aluminum foil, paper or non-woven fabric, the second layer 12 preventing the adhesive from contacting the outer surface 10 and from leakage, and the second layer 12 also enhancing the structural strength of the outer surface 10;

step 2: making a printed pattern 30 on the outer surface 10;

step 3: making a through hole 40 through the outer surface 10 by a blade (not shown);

step 4: making an inner surface 20 which is composed of a high isolation layer 21 and a plastic layer 22 which can be a polyester film, the high isolation layer 21 preventing air and moist from entering the bag 1 so as to keep freshness of the food received in the bag 1, the plastic film 22 enhancing the salability of the high isolation layer 21, and

step 5: connecting the second layer 12 to the high isolation layer 21 by way of non-liquid adhesive so as to form a bag with a window 50, a separation film being used to separate the high isolation layer 21 located at the through hole 40 from being in contact with the roller on the adhesive is spread, so that the window 50 can be kept clear.

While we have shown and described the embodiment in accordance with the present invention, it should be clear to those skilled in the art that further embodiments may be made without departing from the scope of the present invention.

What is claimed is:

1. A method for making a bag with a window, comprising:
a step 1: making an outer surface which is composed of a first layer and a second layer glued to the first layer;
a step 2: making a through hole through the outer surface;
a step 3: making an inner surface which is composed of a high isolation layer and a plastic layer, and
a step 4: connecting the second layer to the high isolation layer by way of non-liquid adhesive so as to form a bag with a window.

2. The method as claimed in claim 1, wherein the first layer of the outer surface includes a printed pattern.

3. The method as claimed in claim 1, wherein a separation film separates the high isolation layer located at the through hole from a roller.

4. The method as claimed in claim 1, the high isolation layer is a polyester film.

5. A bag comprising:
an outer surface composed of a first layer connected to a second layer, a through hole defined through the outer surface;
an inner surface composed of a high isolation layer and a plastic layer, and
the second layer connected to the high isolation layer by way of non-liquid adhesive so as to form the bag.

6. The bag as claimed in claim 5, wherein the first layer is made by electro-coating aluminum foil film, aluminum foil, paper or non-woven fabric.

7. The bag as claimed in claim 5, wherein the first layer includes a printed pattern.

8. The bag as claimed in claim 5, wherein the connection of the first layer and the second layer is made by way of liquid adhesive or non-liquid adhesive.

9. The bag as claimed in claim 5, wherein the connection of the high isolation layer and the plastic layer is made by way of liquid adhesive or non-liquid adhesive.
